(19) United States
(12) Patent Application Publication
(10) Pub. No.: US 2022/0372954 A1
(43) Pub. Date: Nov. 24, 2022

(54) SOLAR PANELLED WINDMILL ASSEMBLY

(71) Applicant: Mohan Rajkumar DEWAN, Pune (IN)

(72) Inventor: Mohan Rajkumar DEWAN, Pune (IN)

(21) Appl. No.: 17/755,293

(22) PCT Filed: Jan. 27, 2021
(86) PCT No.: PCT/IB2021/050609

§ 371 Date: Apr. 26, 2022

(30) Foreign Application Priority Data
Jan. 28, 2020 (IN) 202021003796

(51) Int. Cl. F03D 9/00; H02S 10/12; H02S 20/30

(52) U.S. Cl. CPC F03D 9/007; H02S 10/12; H02S 20/30; F05B 2220/708

(57) ABSTRACT

The present invention envisages a solar paneled windmill assembly(100). The windmill assembly comprises a plurality of solar panels(120), a tower(105), a tilting mechanism, a nacelle(110), a plurality of rotary blades(115) and a plurality of sensors. The plurality of solar panels(120) is configured to convert solar energy into electrical energy. The tower(105) having a plurality of facets is configured to facilitate mounting of the plurality of solar panels(120). The tilting mechanism is coupled to a top portion of the tower(105) and is configured to tilt a nacelle(110), mounted on the tilting mechanism, along a vertical axis of the tower(105). The plurality of rotary blades(115) is coupled to the nacelle(110). A control unit is disposed within the nacelle(110) and is configured to actuate the tilting mechanism. A generation unit disposed within the nacelle(110), is configured to convert wind induced rotational motion of the rotary blades(115) into the electrical energy.

### FIELD

The present disclosure relates to the field of hybrid power harvesting systems.

### BACKGROUND

The background information herein below relates to the present disclosure but is not necessarily prior art.

Renewable energy resources are an easy and cost-effective solution for reducing both electricity costs and carbon emissions. More commonly utilized renewable energy resources are wind energy and solar energy which are generally harvested with the help of windmills and solar panels. However, neither solar energy nor wind energy can continuously produce electric power throughout the year since sometimes the sun stops shining and the wind stops blowing. Interestingly, over the years, it has been understood that the output generated from the solar and wind energy systems follows a highly predictable pattern, thus making it easy to plan for times when output decrease from solar panels or wind turbines.

Based on the pattern of output generated, solar panels and windmills have been separately used till date. However, using both the systems separately is not quite feasible due to lack of land where these systems can be set up, as a result of which the cost of installation increases.

Therefore, there is felt a need for a solution that can trap both wind energy and solar energy at the same time using the same infrastructure.

### OBJECTS

Some of the objects of the present disclosure, which at least one embodiment herein satisfies, are as follows:

An object of the present disclosure is to ameliorate one or more problems of the prior art or to at least provide a useful alternative.

An object of the present disclosure is to provide a solar paneled windmill assembly.

Another object of the present disclosure is to provide a solar paneled windmill assembly that consistently produces electricity throughout the year.

Yet another object of the present disclosure is to provide a solar paneled windmill assembly that does not consume a lot of space for set up.

Still another object of the present disclosure is to provide a solar paneled windmill assembly that provides efficient conversion of solar energy and wind energy into an electrical energy.

Other objects and advantages of the present disclosure will be more apparent from the following description, which is not intended to limit the scope of the present disclosure.

### SUMMARY

The present invention envisages a solar paneled windmill assembly for harvesting electrical energy. The windmill assembly comprises a plurality of solar panels, a tower, a tilting mechanism, a nacelle, a plurality of rotary blades and a plurality of sensors. The plurality of solar panels is configured to convert solar energy into electrical energy. The tower having a plurality of facets is configured to facilitate mounting of the plurality of solar panels. The tilting mechanism is coupled to a top portion of the tower and is configured to tilt a nacelle, mounted on the tilting mechanism, along a vertical axis of the tower. The plurality of rotary blades is coupled to the nacelle. The plurality of sensors is configured to periodically sense a plurality of parameters, and generate sensed signals corresponding to the parameters.

A control unit is disposed within the nacelle, is configured to receive the sensed signals, and to generate a control signal to actuate the tilting mechanism. A generation unit disposed within the nacelle (110), is configured to convert wind induced rotational motion of the rotary blades into the electrical energy.

The control unit comprises a repository, a converter, a comparator, and a controller. The repository is configured to store a look up table having predetermined parameter values and tilt angle values corresponding to each of the sensed parameters. A converter is configured to receive the sensed signals and convert the sensed signals into digital values. The comparator is configured to cooperate with the converter and the repository, and to compare the digital values with the predetermined parameter values to generate comparison values. The controller is configured to cooperate with the comparator and the repository, to select a tilt angle value from the repository based on the comparison value and accordingly generate the control signal. The controller is implemented using one or more processor(s).

The plurality of sensors is mounted on at least one of the tower, the nacelle, and/or the rotary blades. The plurality of sensors is selected from a group consisting of a light sensor, a wind sensor, a pressure sensor, a vibration sensor and combination thereof.

The plurality of parameters includes direction of sun, sunlight intensity, wind direction and wind speed.

The tilting mechanism is configured to rotated along the horizontal axis of the tower.

In an embodiment, at least one of the nacelle and the plurality of rotary blades is configured to mount the plurality of solar panels. The plurality of solar panels is attached to at least one operating surface of the plurality rotary blades. The plurality of rotary blades is made of fiberglass composite material. The plurality of rotary blades is of an aerodynamic configuration.

In another embodiment, the windmill assembly includes at least one of electrical energy storage device and supply terminals. The electrical energy storage device and the supply terminals are configured to receive electrical energy from the plurality of solar panels and the generation unit.

### BRIEF DESCRIPTION OF THE ACCOMPANYING DRAWING

A solar paneled windmill assembly of the present disclosure will now be described with the help of the accompanying drawing, in which:

FIG. 1 illustrates an isometric view of the solar paneled windmill, in accordance with an embodiment of the present disclosure;

FIG. 2 illustrates blades of the solar paneled windmill of FIG. 1, with a solar panel attached thereon;

FIG. 3 illustrates solar panels of the solar paneled windmill of FIG. 1, configured as a blade of the solar paneled windmill; and

FIG. 4 illustrates an isometric view of a tower of the windmill of FIG. 1.

LIST OF REFERENCE NUMERALS USED IN
DETAILED DESCRIPTION AND DRAWING

| | |
|---|---|
| 100 | Solar paneled windmill assembly |
| 105 | Tower |
| 105A | Facet |
| 110 | Nacelle |
| 115 | Rotary blade |
| 120 | Solar panel |

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a”, “an” and “the” may be intended to include the plural forms as well, unless the context clearly suggests otherwise. The terms “comprises”, “comprising”, “including” and “having” are open-ended transitional phrases and therefore specify the presence of stated features, elements, modules, units and/or components, but do not forbid the presence or addition of one or more other features, elements, components, and/or groups thereof.

When an element is referred to as being “mounted on”, “engaged to”, “connected to” or “coupled to” another element, it may be directly on, engaged, connected or coupled to the other element. As used herein, the term “and/or” includes any and all combinations of one or more of the associated listed elements.

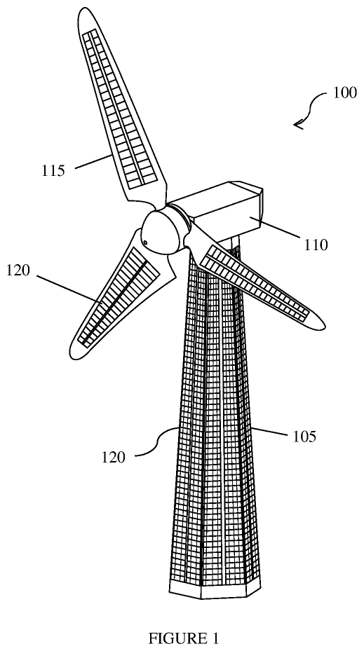

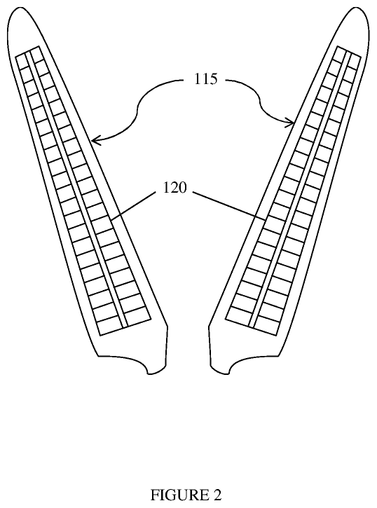

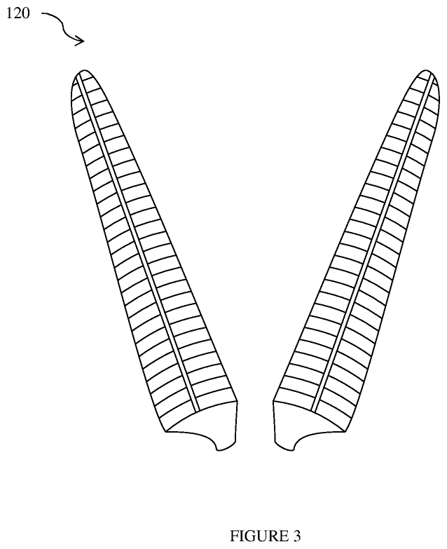

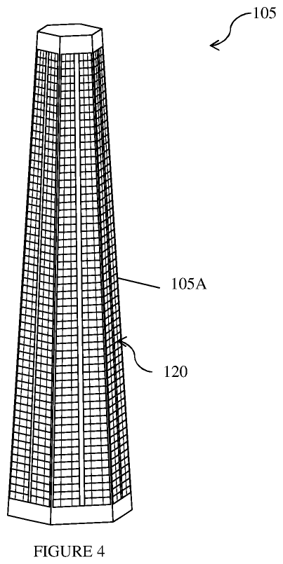

A preferred embodiment of a solar paneled windmill assembly (hereinafter referred to as windmill assembly (100)) of the present disclosure will now be described with respect to FIG. 1 through FIG. 4. The preferred embodiment does not limit the scope and ambit of the present disclosure.

In accordance with the present disclosure, the windmill assembly (100) comprises a tower (105), a tilting mechanism, a nacelle (110), a plurality of rotary blades (115), a plurality of sensors and a plurality of solar panels (120).

The tower (105) has a plurality of facets (105A) and is configured to facilitate mounting of the plurality of solar panels (120) thereon, in a vertical configuration. Providing the facets (105A) on the tower (105), instead of having a cylindrical configuration, allows ease in mounting the solar panels (120) on the facets (105A).

The tilting mechanism is coupled to a top portion of the tower (105). The tilting mechanism configured to tilt a nacelle (110), mounted on the tilting mechanism, along a vertical axis of the tower (105). In an embodiment, the tilting mechanism is configured to rotate along the horizontal axis of the tower (105).

The plurality of sensors is mounted on at least one of the tower (105), the nacelle (110), and/or the rotary blades (115). The sensors are configured to periodically sense a plurality of parameters, and generate sensed signals corresponding to the parameters. The plurality of parameters includes direction of sun, sunlight intensity, wind direction and wind speed. The plurality of sensors is selected from a group consisting of a light sensor, a wind sensor, a pressure sensor, a vibration sensor and combination thereof.

The plurality of rotary blades (115) is coupled to the nacelle (110).

The nacelle (110) is adapted to be mounted on the tilting mechanism. The nacelle (110) is configured to house therein a control unit and a generation unit. The control unit is configured to receive the sensed signals, and to generate a control signal to actuate the tilting mechanism.

The nacelle (110) can be tilted from a vertical position with respect to the direction of sun or sunlight intensity. The tilting mechanism includes an actuator, a plurality of hinges, a platform, a flexible member and a joint. The tilting mechanism eliminates the need of additional trackers for tracking and guiding the solar panels (120) along the angle of sun rays. The tilting mechanism is also configured to tilt the nacelle (110) according to the analysis of wind conditions based on, such as, wind direction and wind speed at a place where the windmill assembly (100) is located.

The control unit comprises a repository, a converter, a comparator, and a controller. The repository is configured to store a look up table having predetermined parameter values and tilt angle values corresponding to each of the sensed parameters. The converter is configured to receive the sensed signals and convert the sensed signals into digital values. The comparator is configured to cooperate with the converter and the repository, and to compare the digital values with the predetermined parameter values to generate comparison values. The controller is configured to cooperate with the comparator and the repository, to select the tilt angle value from the repository based on the comparison value and accordingly generate the control signal. In an embodiment, the control unit is configured to generate a control signal to rotate the tilting mechanism.

The controller is implemented using one or more processor(s). The processor may be a general-purpose processor, a Field Programmable Gate Array (FPGA), an Application Specific Integrated Circuit (ASIC), a Digital Signal Processor (DSP), a microprocessor, a microcontroller, or a state machine. The processor may also be implemented as a combination of computing devices, e.g., a combination of a DSP and a microprocessor, a plurality of microprocessors, one or more microprocessors in conjunction with a DSP core, or any other such configuration.

The repository may be, for example, a random-access memory (RAM), a memory buffer, a hard drive, a database, an erasable programmable read only memory (EPROM), an electrically erasable programmable read only memory (EEPROM), a read only memory (ROM), a flash memory, and/or so forth.

A generation unit is disposed within the nacelle (110). The generation unit is configured to convert wind induced rotational motion of the rotary blades (115) into the electrical energy. The generation unit includes a main drive shaft, a gearbox, a generator, and a blade pitch and yaw control. The rotary blades (115) have an aerodynamic configuration which ensures that the blades (115) are rotated by wind. In an embodiment, the generation unit includes a braking mechanism and is configured to brake the rotation of the rotary blades (115). The shaft, the gearbox, and the pitch and yaw controls are connected to the blades (115), and converts the wind induced rotational motion of the rotary blades (115) into the electrical energy.

In an embodiment, at least one of the nacelle (110) and the plurality of rotary blades (115) is configured to mount the plurality of solar panels (120). The plurality of solar panels (120) is attached to at least one operating surface of the plurality rotary blades (115). To balance the weight thereof, the blades (115) are manufactured from fiberglass composites. In another embodiment, a plurality of bi-paneled solar panels (120) is directly bolted to the nacelle (110), wherein the solar panels (120) produce electrical energy from solar energy, and are also rotated by the wind to facilitate production of electrical energy from wind energy.

The solar panels (120) are used to convert solar radiation to electrical energy by means of photovoltaic cells. The photovoltaic cells capture the energy of incident light to create a potential gradient, get accelerated under the electric field, and circulate as current through an external circuit, thereby providing electrical energy. The windmill assembly (100) is used for extracting energy from wind by rotation of the blades (115). As the wind speed increases power generation is also increases. In an embodiment, the windmill assembly (100) includes at least one of electrical energy storage device and supply terminals. The electrical energy storage device and supply terminals are configured to receive electrical energy from the plurality of solar panels (120) and the generation unit. The electrical energy storage device stores the electrical energy received from the solar panels (120) and the generation unit. Further, the energy storage device is configured to supply electrical energy to a load. Advantageously, the windmill assembly (100) can provide electrical energy directly to the load through the supply terminals.

In a working environment, the repository of the windmill assembly (100) is configured to store a look up table having predetermined parameter values and tilt angle values for parameters such as the direction of sun, sunlight intensity, wind direction and wind speed. For instance, the light sensor senses the direction of sun, and generates the corresponding sensed signal. The control unit receives the sensed signal corresponding to the direction of sun, converts the sensed signal into the digital value, compares the digital value with the stored predetermined parameter value corresponding to the direction of sun, generates the comparison value, based on the comparison value the tilt angle value is selected and the control signal is generated to actuate the tilting mechanism. The nacelle (110) mounted on the tilting mechanism tilts accordingly with respect to the direction of sun, thereby, facilitating the solar panels mounted on the rotary blades to continuously remain exposed to the sunlight throughout the daytime and provide efficient conversion of the solar energy into the electrical energy. For another instance, the wind sensor senses the direction of the wind and the control unit actuates the tilting mechanism to tilt the nacelle (110) accordingly with respect to the direction of wind. Further, the control unit can generate a control signal to rotate the titling mechanism along the direction of horizontal axis of the tower (105), based on the direction of the wind. Thereby, facilitating efficient conversion of the wind energy into the electrical energy.

Advantageously, the present invention also includes a safety feature, where in the rotation of the rotary blades can be halted with the help of the braking mechanism. This safety feature is beneficial for avoiding any damage to the rotary blades (115), in situations like a stormy or high windy weather, when the rotary blades (115) rotate at a very highspeed.

The solar paneled windmill assembly (100), of the present disclosure, facilitates production of a consistent source of electricity throughout the year, with the strengths of each resource i.e., wind energy and solar energy balancing the other's weaknesses. As production from one energy resource dwindles daily or seasonally, the other picks up the slack.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### TECHNICAL ADVANCEMENTS AND ECONOMIC SIGNIFICANCE

The present disclosure described herein above has several technical advantages including, but not limited to, the realization of a solar paneled windmill assembly that:
consistently produces electricity throughout the year; and
does not consume a lot of space for its set up.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A solar paneled windmill assembly (100) for harvesting electrical energy, wherein said assembly (100) comprising:
a plurality of solar panels (120) configured to convert solar energy into electrical energy;
a tower (105) having a plurality of facets (105A) configured to facilitate mounting of said plurality of solar panels (120);
a tilting mechanism coupled to a top portion of said tower (105) and configured to tilt a nacelle (110), mounted on said tilting mechanism, along a vertical axis of said tower (105);
a plurality of rotary blades (115) coupled to said nacelle (110);
a plurality of sensors configured to periodically sense a plurality of parameters, and generate sensed signals corresponding to said parameters;
a control unit disposed within said nacelle (110), configured to receive said sensed signals, and to generate a control signal to actuate said tilting mechanism; and
a generation unit disposed within said nacelle (110), configured to convert wind induced rotational motion of said rotary blades (115) into said electrical energy.

2. The assembly (100) as claimed in claim 1, wherein said control unit comprises:
a repository configured to store a look up table having predetermined parameter values and tilt angle values corresponding to each of said sensed parameters;
a converter configured to receive said sensed signals and convert said sensed signals into digital values;
a comparator configured to cooperate with said converter and said repository, and to compare said digital values with said predetermined parameter values to generate comparison values; and
a controller configured to cooperate with said comparator and said repository, to select a tilt angle value from said repository based on said comparison value and accordingly generate said control signal,
wherein said controller is implemented using one or more processor(s).

3. The assembly (100) as claimed in claim 1, wherein said plurality of sensors is mounted on at least one of said tower (105), said nacelle (110), and/or said rotary blades (115).

4. The assembly (100) as claimed in claim 1, wherein said plurality of sensors is selected from a group consisting of a light sensor, a wind sensor, a pressure sensor, a vibration sensor and combination thereof.

5. The assembly (100) as claim in claim 1, wherein said plurality of parameters includes direction of sun, sunlight intensity, wind direction and wind speed.

6. The assembly (100) as claimed in claim 1, wherein said tilting mechanism configured to rotated along a horizontal axis of said tower (110).

7. The assembly (100) as claimed in claim 1, wherein said nacelle (110) and said plurality of rotary blades (115) is configured to mount said plurality of solar panels (120).

8. The assembly (100) as claimed in claim 1, wherein said plurality of solar panels (120) is attached to at least one operating surface of said plurality rotary blades (115).

9. The assembly (100) as claimed in claim 1, wherein said plurality of rotary blades (115) is made of fiberglass composite material.

10. The assembly (100) as claimed in claim 1, includes at least one electrical energy storage device and supply terminal configured to receive electrical energy from said plurality of solar panels (120) and said generation unit.

11. The assembly (100) as claimed in claim 1, wherein said plurality of rotary blades (115) is of an aerodynamic configuration.
